(19) United States
(12) Patent Application Publication
(10) Pub. No.: US 2016/0344169 A1
(43) Pub. Date: Nov. 24, 2016

(54) DRAW WIRE APPARATUS FOR THREADING A DRAW WIRE

(71) Applicant: GAVRIEL GABI HASSON, KIRYAT ONO (IL)

(72) Inventor: GAVRIEL GABI HASSON, KIRYAT ONO (IL)

(21) Appl. No.: 15/157,513

(22) Filed: May 18, 2016

(30) Foreign Application Priority Data
May 20, 2015 (IL) 238925

(51) Int. Cl. H02G 1/00

(52) U.S. Cl. CPC H02G 1/00

(57) ABSTRACT

A draw wire apparatus, including: a first tube, for housing a draw wire, and for attaching an end of the first tube to a conduit, into which the draw wire is to be threaded; a second tube, for housing the draw wire, the second tube being juxtaposed to the first tube and slideable in relation thereto, wherein second tube allows to contact the draw wire to the second tube, for sliding the second tube and the draw wire into the first tube, thereby applying the threading of the draw wire into the conduit, and to release the contacting, for sliding the second tube away from the first tube, while maintaining a location of the draw wire, for repeating the threading.

### CROSS-REFERENCE TO RELATED APPLICATIONS

This application claims the benefit of priority from Israel Patent Application No. 238925, filed May 20, 2015, the disclosure of which is incorporated herein by reference.

### TECHNICAL FIELD

The invention relates to the field of draw wires. More particularly, the invention relates to a tool and method for threading thereof into a conduit.

### BACKGROUND

FIG. 1 depicts prior art threading of a draw wire.

A fish tape, also known as a draw wire or draw tape, is a tool used by electricians to route new wiring through walls and electrical conduit.

FIG. 1 depicts a draw wire 18 being threaded into a conduit 58. The electrician holds draw wire 18 and presses it along arrow 44.

At the next step (not shown) the electrician ties an electric wire to the end of draw wire 18, and pulls the other end of draw wire 18, thus threads the electric wire into conduit 58.

This process is known to be difficult. Motorized threading might break obstacles disposed within the conduit, and thus is not applied.

In one aspect of the invention, the invention provides a method and apparatus for providing convenient manual threading of the draw wire into a conduit.

In one aspect, the invention provides a solution to the above-mentioned and other problems of the prior art.

Other aspects of the invention will become apparent as the description proceeds.

### SUMMARY

In one aspect, the invention is directed to a draw wire apparatus (10), including:
a first tube (12), for housing a draw wire (18), and for attaching an end (46, 56) of the first tube (12) to a conduit (58), into which the draw wire (18) is to be threaded;
a second tube (14), for housing the draw wire (18), the second tube (14) being juxtaposed to the first tube (12) and slideable in relation thereto, wherein second tube (14) allows
to contact the draw wire (18) to the second tube (14), for sliding the second tube (14) and the draw wire (18) into the first tube (12), thereby applying the threading of the draw wire (18) into the conduit (58), and
to release the contacting, for sliding the second tube (14) away from the first tube (12), while maintaining a location of the draw wire (18), for repeating the threading.

### BRIEF DESCRIPTION OF THE DRAWINGS

Embodiments, features, and aspects of the invention are described herein in conjunction with the following drawings in which:

FIG. 1 depicts prior art threading of a draw wire;

FIG. 2 is a front sectional view of a draw wire apparatus according to one embodiment of the present invention;

FIG. 3 is a front perspective view of the first, second, and third steps of using the draw wire apparatus of FIG. 2;

FIG. 4 is a front perspective view of the fourth step of using the draw wire apparatus of FIG. 2;

FIG. 5 depicts braking components, which may be added to the draw wire apparatus of FIG. 2.

The drawings are not necessarily drawn to scale.

### DETAILED DESCRIPTION

The invention will be understood from the following detailed description of preferred embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

FIG. 2 is a front sectional view of a draw wire apparatus according to one embodiment of the present invention.

A draw wire apparatus 10 includes a stationary tube 12 and a slideable tube 14, for sliding thereof back and forth in relation to stationary tube 12.

Slideable tube 14 may be accompanied by a handle 16, for applying the sliding motions in relation to stationary tube 12.

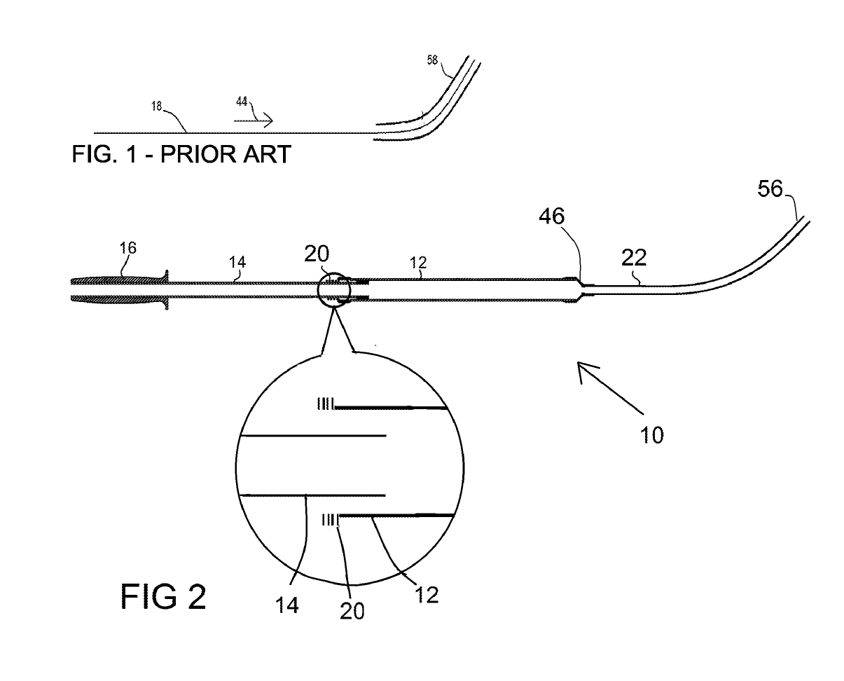

Stationary tube 12 and slideable tube 14 both are unbendable. A bendable tube 22 may be fixed to the end 46 of stationary tube 12, for later connecting the end 56 of bendable tube to conduit 58 of FIG. 1.

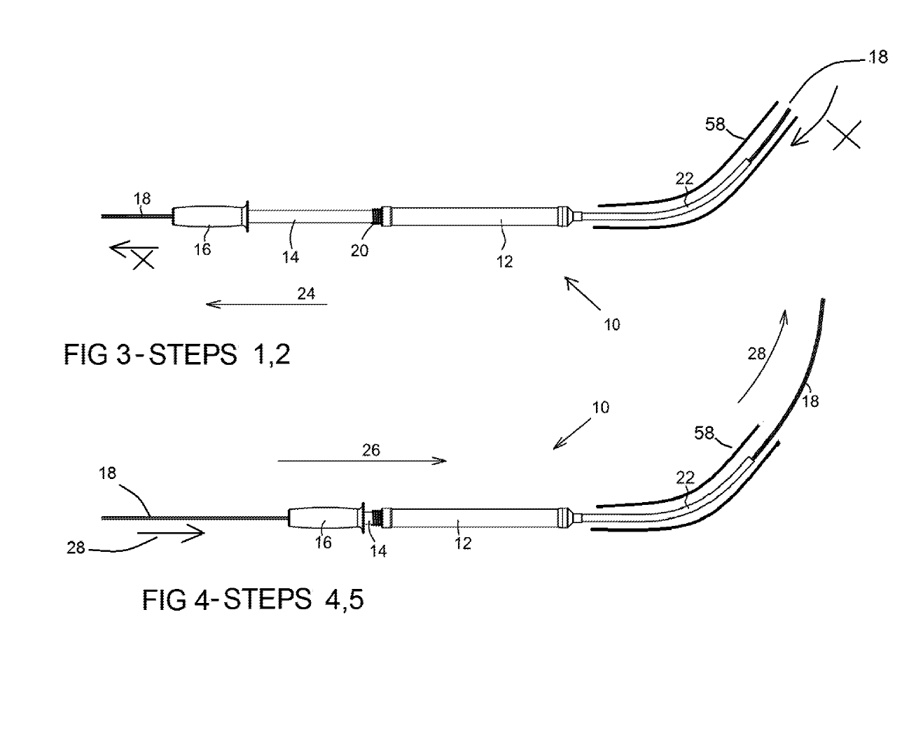

FIG. 3 is a front perspective view of the first, second, and third steps of using the draw wire apparatus of FIG. 2.

At the first step, draw wire 18 of FIG. 1 is inserted into slideable tube 14, and further into stationary tube 12, and further into bendable tube 22.

At the second step, bendable tube 22 in inserted into conduit 58 of FIG. 1 as depicted in FIG. 3, or conduit 58 of FIG. 1 is inserted into bendable tube 22.

At the third step, the electrician draws slideable tube 14 away from stationary tube 12, as depicted by arrow 24, without pulling draw wire 18 to this direction, as depicted by the X arrow.

FIG. 4 is a front perspective view of the fourth step of using the draw wire apparatus of FIG. 2.

At the fourth step, the electrician contacts draw wire 18 to slideable tube 14.

At the fifth step, the electrician slides slideable tube 14 towards stationary tube 12 as depicted by arrow 26, together with draw wire 18 as depicted by arrow 28, due to the contacting step of the fourth step.

The electrician repeats the first to the fifth steps on and on.

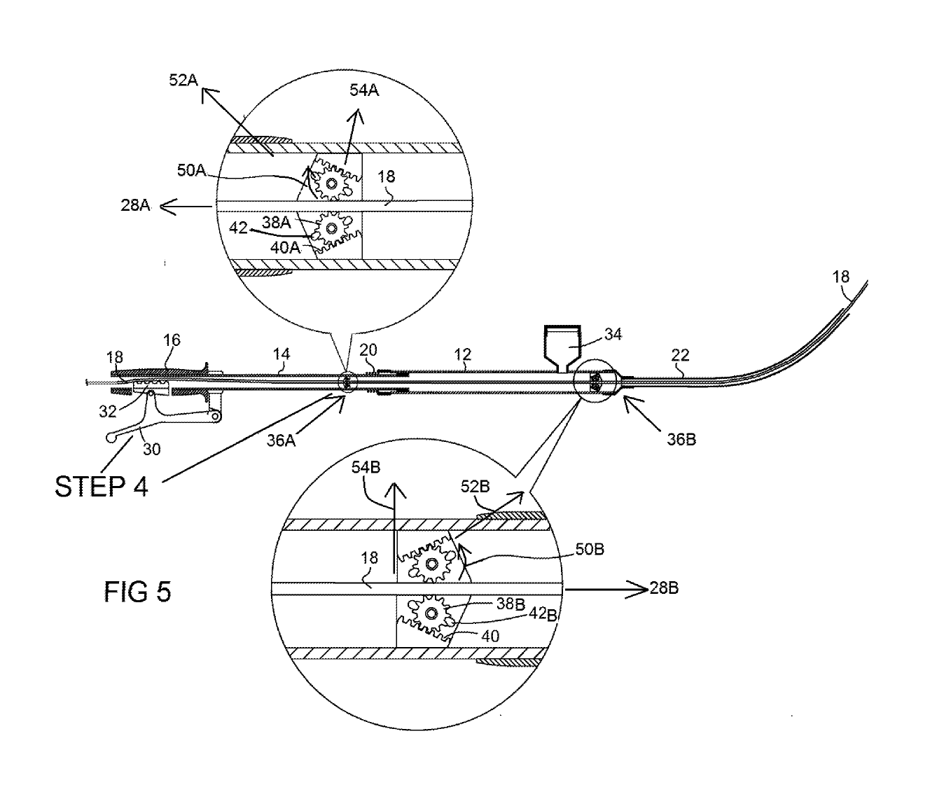

FIG. 5 depicts braking components, which may be added to the draw wire apparatus of FIG. 2.

The fourth step of contacting draw wire 18 to slideable tube 14, may be applied by a manual braking lever 30, being a part of handle 16. Braking lever 30, upon being manually pressed by the electrician, presses a braking element 32 on draw wire 18, for producing friction between draw wire 18 and slideable tube 14.

The fourth step of contacting draw wire 18 to slideable tube 14, may be applied by an automatic brake 36A, being a one-way brake disposed within slideable tube 14, for allowing only insertion of draw wire 18 into conduit 58, and not allowing drawing of draw wire 18 outwards, by producing friction between draw wire 18 and slideable tube 14.

According to this embodiment, automatic brake 36A includes cogged wheels 38A, braking draw wire 18 upon contacting thereof. Upon pressing draw wire 18 to direction 28A, which should be enabled, cogged wheel cog 38A rotates along rotational direction 50A due to a tilted cogged bar 40A. Cogged wheel 38A slides within a tilted slit 42A along arrow 52A, and thus draws cogged wheel 38A along arrow 54A, i.e., away from draw wire 18, thus ceasing the braking of draw wire 18, and enabling the sliding of draw wire 18.

Draw wire apparatus 10 may further include an automatic brake 36B disposed within stationary tube 12, being a one-way brake, allowing only insertion of draw wire 18 into conduit 58, and not allowing drawing of draw wire 18 outwards, by producing friction between draw wire 18 and stationary tube 12.

According to one embodiment, automatic brake 36B includes cogged wheels 38B, braking draw wire 18 upon contacting thereof. Upon pressing draw wire 18 to direction 28B, which should be enabled, cogged wheel cog 38B rotates along rotational direction 50B due to a tilted cogged bar 40. Cogged wheel 38B slides within a tilted slit 42B along arrow 52B, and thus draws cogged wheel 38B along arrow 54B, i.e., away from draw wire 18, thus ceasing the braking of draw wire 18, and enabling the sliding of draw wire 18.

Stationary tube 12 may include an inlet 34, for inserting lubricating oil to draw wire.

Thus, in one aspect, the invention is directed to a draw wire apparatus (10), including:
a first tube (12), for housing a draw wire (18), and for attaching an end (46, 56) of the first tube (12) to a conduit (58), into which the draw wire (18) is to be threaded;
a second tube (14), for housing the draw wire (18), the second tube (14) being juxtaposed to the first tube (12) and slideable in relation thereto, wherein second tube (14) allows
to contact the draw wire (18) to the second tube (14), for sliding the second tube (14) and the draw wire (18) into the first tube (12), thereby applying the threading of the draw wire (18) into the conduit (58), and
to release the contacting, for sliding the second tube (14) away from the first tube (12), while maintaining a location of the draw wire (18), for repeating the threading.

The draw wire apparatus (10) may further include temporal contact means (30, 36A), for providing the contacting of the draw wire (18) to the second tube (14), and for providing the releasing of the contacting.

The temporal contact means (30, 36A) for providing the contacting of the draw wire (18) to the second tube (14) may include a manual braking lever (30).

The temporal contact means (30, 36A) for providing the contacting of the draw wire (18) to the second tube (14) may include an automatic brake (36A).

The draw wire apparatus (10) may further include:
an automatic brake (36A),
for contacting the draw wire (18) to the first tube (14), for not allowing sliding the draw wire (18) in relation to the first tube (12) against the threading direction (28), and
for releasing the contacting, for allowing sliding the draw wire (18) in relation to the first tube (12) along the threading direction (28).

The draw wire apparatus (10) may further include:
a bendable tube (22) fixed to an end (46) of the first tube (12), for connecting an end (56) of the bendable tube (22) to the conduit (58) in a conformable manner.

The draw wire apparatus (10) may further include:
a lubricating oil inlet (34), for supplying lubricating oil to the draw wire (18).

In another aspect, the invention is directed to a method for threading a draw wire (18) into a conduit (22), the method including the steps of:
a) attaching an end (46, 56) of a first tube (12) to the conduit (58);
b) inserting the draw wire (18) into the first tube (12) and into a second tube (14) juxtaposed to the first tube (12);
c) sliding the second tube (14) away from the first tube (12), while maintaining the location of the draw wire (18);
d) contacting the draw wire (18) to the second tube (14);
e) sliding the second tube (14) and the draw wire (18) into the first tube (12), thereby threading the draw wire (18) into the conduit (58);
f) releasing the contacting of the draw wire (18) from the second tube (14); and
g) repeating steps c to f.

The step of contacting the draw wire (18) to the second tube (14) may comprise contacting by a hand of a user, and the step of releasing the contacting may comprise ceasing the contacting by the user's hand.

The step of contacting the draw wire (18) to the second tube (14) may comprise manual pressing of a braking lever (30), and the step of releasing the contacting may comprise ceasing the manual pressing of the braking lever (30).

The step of contacting the draw wire (18) to the second tube (14) and the step of releasing the contacting may comprise automatic braking and ceasing of the braking according to a direction of the motion of the draw wire (18) in relation to the first tube (12).

In the figures and/or description herein, the following reference numerals (Reference Signs List) have been mentioned:
numeral 10 denotes a draw wire apparatus, being a tool for helping the electrician to thread the draw wire into a conduit, according to one embodiment of the invention;
numeral 12 denotes the stationary tube, facing the conduit;
numeral 14 denotes the slideable tube, facing the electrician;
numeral 16 denotes the handle, for sliding the slideable tube;
numeral 18 denotes the draw wire;
numeral 20 denotes a spring, fixed to the stationary tube, for softening the hits of the slideable tube on the stationary tube;
numeral 22 denotes a bendable tube, extending from the stationary tube;
numerals 24, 26, 28, 28A, and 28B denote arrows, each indicating a direction;
numeral 30 denotes a braking lever;
numeral 32 denotes a braking element;
numeral 34 denotes an inlet for lubrication oil; the inlet may further include an oil container;
numerals 36A and 36B denote automatic brakes;
numerals 38A and 38B denote cogged wheels;
numerals 40A and 40B denote cogged bars;
numerals 42A and 42B denote tilted slits;
numeral 44 denotes an arrow indicating a direction;
numeral 46 denotes the end of the stationary tube;
numerals 50A and 50B denote arrows indicating rotational directions;
numerals 52A, 52B, 54A, 54B denote arrows, each indicating a direction;
numeral 56 denotes the end of the bendable tube; and
numeral 58 denotes the conduit, into which the draw wire is to be threaded.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A draw wire apparatus, comprising:
a first tube, for housing a draw wire, and for attaching an end of said first tube to a conduit, into which the draw wire is to be threaded;
a second tube, for housing the draw wire, said second tube being juxtaposed to said first tube and slideable in relation thereto,
wherein second tube allows
to contact the draw wire to said second tube, for sliding said second tube and the draw wire into said first tube, thereby applying the threading of the draw wire into the conduit, and
to release said contacting, for sliding said second tube away from said first tube, while maintaining a location of the draw wire, for repeating said threading.

2. A draw wire apparatus according to claim 1, further comprising temporal contact means, for providing said contacting of the draw wire to said second tube, and for providing said releasing of said contacting.

3. A draw wire apparatus according to claim 2, wherein said temporal contact means for providing said contacting of the draw wire to said second tube comprises a manual braking lever.

4. A draw wire apparatus according to claim 2, wherein said temporal contact means for providing said contacting of the draw wire to said second tube comprises an automatic brake.

5. A draw wire apparatus according to claim 1, further comprising:
an automatic brake,
for contacting the draw wire to said first tube, for not allowing sliding the draw wire in relation to said first tube against a threading direction, and
for releasing said contacting, for allowing sliding the draw wire in relation to said first tube along the threading direction.

6. A draw wire apparatus according to claim 1, further comprising:
a bendable tube fixed to an end of said first tube, for connecting an end of said bendable tube to the conduit in a conformable manner.

7. A draw wire apparatus according to claim 1, further comprising:
a lubricating oil inlet, for supplying lubricating oil to the draw wire.
